(19) United States
(12) Patent Application Publication
(10) Pub. No.: US 2019/0036706 A1
(43) Pub. Date: Jan. 31, 2019

(54) INTEGRATED CIRCUIT WITH ANTI-COUNTERFEITING CAPABILITIES

(71) Applicant: RENESAS ELECTRONICS EUROPE GMBH, Duesseldorf (DE)

(72) Inventor: Thomas DETERT, Duesseldorf (DE)

(73) Assignee: Renesas Electronics Europe GmbH, Duesseldorf (DE)

(21) Appl. No.: 16/071,517

(22) PCT Filed: Jan. 20, 2016
(86) PCT No.: PCT/EP2016/051085

§ 371 Date: Jul. 20, 2018

(51) Int. Cl. H04L 9/32; G06K 19/07; H04L 9/30; H04L 9/14

(52) U.S. Cl. CPC H04L 9/3247; G06K 19/07; H04L 2209/26; H04L 9/14; H04L 9/30

(57) ABSTRACT

An integrated circuit is described. The integrated circuit comprises a one-time programmable non-volatile memory and a memory controller for the one-time programmable non-volatile memory. The memory controller is configured to send a first random number which has been generated in the integrated circuit to a device initialization server. The memory controller is configured, in response to receiving a signed device initialization message from the device initialization server, the signed device initialization message comprising a device initialization message and a corresponding signature, and the device initialization message comprising a second random number and a device identity, to determine whether the first and second random numbers are equal and whether the signature is valid. The memory controller is configured, in response to determining that the first and second random numbers are equal and that the signature is valid to program the device identity into a first part of the one-time programmable non-volatile memory.

### FIELD OF THE INVENTION

The present invention relates to an integrated circuit, such as a microcontroller or a system-on-a-chip.

### BACKGROUND

Counterfeiting is becoming an increasing problem in the semiconductor industry and original equipment manufacturers (OEMs).

There are two aspects to the problem. The first aspect concerns counterfeit integrated circuits and the grey market in such integrated circuits. The second aspect arises from the fact that OEMs make and market products which incorporate integrated circuits. Counterfeit products may be made and marketed which employ integrated circuits that may be genuine, stolen (for example from the fabrication plant, in transit or from a warehouse) or counterfeit.

Conceptually the simplest approach to producing counterfeit integrated circuits is to duplicate or clone a genuine integrated circuit. However, this approach is technically onerous and prohibitively expensive thereby making it extremely unattractive to counterfeiters.

Other techniques, however, are much simpler. For example, it is easiest and cheapest merely to steal integrated circuits from a fabrication plant or warehouse. This is particularly attractive to counterfeiters in “fab-less” and “fab-light” production environments, i.e. arrangements in which a vendor subcontracts device fabrication to an independently-run fabrication plant. Moreover, the fabrication plant may be able to fabricate surplus integrated circuits unbeknownst to the vendor which can then be placed on the grey market.

To counter this problem, various counterfeiting countermeasures have been proposed. Many of these approaches employ a trusted server located at the fabrication plant or elsewhere to enable features in an integrated circuit in a secure way and/or to keep track of production.

Some of these approaches employ on-chip fuse read-only memory that are used for configuring and enabling features and which can only be accessed or blown using passphrases or encrypted messages. Reference is made to CN103187095 A, US 2006/131743 A1 and US 2014/0185795 A1. Certain approaches may employ physical unclonable functions (PUFs) or other codes that are unique to an integrated circuit, as described, for example, in WO 2015/124673 A1.

### SUMMARY

According to a first aspect of the present invention there is provided an integrated circuit comprising one-time programmable non-volatile memory and a memory controller for the one-time programmable non-volatile memory. The memory controller is configured to send a first random number which has been generated in the integrated circuit to a device initialization server. The memory controller is configured, in response to receiving a signed message from the device initialization server comprising a device initialization message which comprises a second random number and a device identity, and a corresponding signature (or “first signature”) to determine whether the first and second random numbers are equal and whether the signature is valid. The memory controller is configured, in response to determining that the first and second random numbers are equal and that the signature is valid, to program the device identity into a first part of the one-time programmable non-volatile memory.

Thus, the integrated circuit may be initialized using a plaintext signed message without the need for storing private keys or passphrases in the integrated circuit.

The one-time programmable non-volatile memory may be a read-only memory which is based on fuses, anti-fuses or other similar form of one-time programmable non-volatile memory element.

The device initialization server is preferably a trusted server. The device initialization server may have a hardware security module (HSM) or other arrangement for making the server secure. The device initialization server may be locally located, i.e. off-chip, but located in the same location as the integrated circuit (such as a semiconductor fabrication plant) or be remotely located, such as at an IP owner or vendor site or the site of an authorized agent or representative.

The device initialization message may be a concatenation of the second random number and the device identity. The signed device initialization message may be a concatenation of the device initialization message and the signature.

The memory controller is may be implemented as a hardware circuit, for example, comprising hardware-implemented logic, registers et cetera, or in software using a CPU sub-system that is dedicated to controlling the one-time programmable non-volatile memory, i.e. a CPU sub-system which is separate from a main CPU sub-system.

The memory controller may be further configured to read the device identity from the first part of the one-time programmable non-volatile memory and to determine whether the device identity read from the first part of the one-time programmable non-volatile memory and the device identity programmed into the first part of the one-time programmable non-volatile memory are equal, i.e. the same. The memory controller may be further configured, in response to determining that the device identities are equal, to program an identity valid value into a second part of the one-time programmable non-volatile memory.

The memory controller may be further configured to read the identity valid value from the second part of the one-time programmable non-volatile memory and to determine whether the identity valid value read from the second part of the one-time programmable non-volatile memory and the identity valid value programmed into the second part of the one-time programmable non-volatile memory are equal. The memory controller may be further configured, in response to determining that the identity valid values are equal, to send a message to the device initialization server for confirming that device initialization has been completed.

The integrated circuit may further comprise a random number generator configured to generate a random number and to provide the random number to the memory controller.

The random number generator is preferably a true random number generator.

The random number generator may generate and provide the random number to the memory controller in response to a request from the memory controller.

The integrated circuit may further comprise a public cryptographic engine configured, in response to receiving data from the memory controller, to build a digest in dependence on the data. For example, the data may comprise the device initialization message comprising a second random number and a device identity.

The integrated circuit may further comprise a function enabler configured, in dependence upon values in the one-time programmable non-volatile memory, to enable (or “activate”) one or more functions (or “features”).

The memory may further comprise a third part for storing a value indicating which enableable function(s) of the integrated circuit is (are) enabled and a fourth part for storing a value indicating which disableable function(s) of the integrated circuit is (are) disabled. The value indicating which disableable function(s) of the integrated circuit is (are) disabled may be a value which indicates that no disableable function(s) are disabled.

The memory controller may be configured to send a third random number which has been generated in the integrated circuit to a feature activation server (which may be the same as or different from the device initialization server) and content of the first, second, third and fourth parts of the one-time programmable non-volatile memory. The memory controller may be configured, in response to receiving a signed function enablement message from the feature activation server, the signed function enablement message comprising a function enablement message and a corresponding signature (or “second signature”), the function enablement message comprising a fourth random number, a purported device identity, a purported identity valid value, a functional enable value and a disable value, to determine whether the third and fourth random numbers are equal and whether the signature (i.e. second signature) is valid. The memory controller may be configured, in response to determining the third and fourth random numbers are equal and that the signature (i.e. second signature) is valid to program the function enable value in the third part of the one-time programmable non-volatile memory.

The memory controller may be configured to send to send a fifth random number which has been generated in the integrated circuit to a feature deactivation server and content of the first, second, third and fourth parts of the one-time programmable memory and, in response to receiving a signed feature disablement message from the feature deactivation server, the signed feature disablement message comprising a feature disablement message and a signature, the feature disablement message comprising a sixth random number, a purported device identity, a purported identity valid value, a function enable value and a disable value, to determine whether the fifth and sixth random numbers are equal and whether the signature is valid and, in response to determining the fifth and sixth random numbers are equal and that the signature is valid, to program the disable value into the fourth part of the one-time programmable non-volatile memory. Feature deactivation may involve deactivating all disableable features which may result in an integrated circuit which has no functions.

According to a second aspect of the present invention there is provided an integrated circuit comprising a one-time programmable non-volatile memory comprising a first part storing a device identity, a second part storing an identity valid value indicating that the device identity is valid, a third part for storing a value indicating which enableable function(s) of the integrated circuit is (are) enabled and a fourth part storing a value indicating which disableable function(s) of the integrated circuit is (are) disabled. The value may indicate that no functions are disabled. The integrated circuit comprises a memory controller for the one-time programmable non-volatile memory. The memory controller may be configured to send a third random number which has been generated in the integrated circuit to a feature activation server (which may be the same as or different from the device initialization server) and content of the first, second, third and fourth parts of the one-time programmable non-volatile memory. The memory controller may be configured, in response to receiving a signed function enablement message from the feature activation server, the signed function enablement message comprising a function enablement message and a corresponding signature (or “second signature”), the function enablement message comprising a fourth random number, a purported device identity, a purported identity valid value, a functional enable value and a disable value, to determine whether the third and fourth random numbers are equal and whether the signature (i.e. second signature) is valid. The memory controller may be configured, in response to determining the third and fourth random numbers are equal and that the signature (i.e. the second signature) is valid to program the functional enable value in the third part of the one-time programmable non-volatile memory.

The integrated circuit may be a digital integrated circuit. The integrated circuit may include memory. The memory may be volatile memory such as DRAM or SRAM. The memory may be non-volatile memory, such as EPROM, EEPROM, NOR flash or NAND flash. The integrated circuit may be a micro integrated circuit, such as a microprocessor, microcontroller or signal processing chip. The integrated circuit may be a microcontroller with embedded Flash memory. The integrated circuit may be a processor without embedded Flash memory. The integrated circuit may be a system-on-a-chip (SoC). The integrated circuit may a logic integrated circuit, such as application-specific integrated circuit chip, standard logic or display driver. The integrated circuit may be a fixed-logic integrated circuit. The integrated circuit may include a field-array gate array (FPGA).

According to a third aspect of the present invention there is provided a product or system which includes at least one integrated circuit according to first or second aspect of the present invention.

The product may be an industrial system, such as plant, control for a plant, a robot or control for a robot.

The product may be a vehicle. The product may be a motor vehicle. The motor vehicle may be a motorcycle, an automobile (sometimes referred to as a “car”), a minibus, a bus, a truck or lorry. The motor vehicle may be powered by an internal combustion engine and/or one or more electric motors. The product may be a train vehicle, such as a drive unit (sometime referred to as a “train engine”) or a train carriage. The product may be an aerospace vehicle, such as an aeroplane or space vehicle.

The product may be a signalling device for use in a transport system. The signalling device may be off-vehicle, for example, trackside signalling for a train.

The product may be a medical system, such as, monitors for monitoring vital signs such as heart rate, breathing rate et cetera. The medical system may include a remote device and a local device (“home device”) capable of wireless communication with the remote device. The remote device may be implantable.

The product may be provided with network capability, preferably wireless network capability. The networkable product may be provided with a device identity, preferably a unique identity. The identifiable, networkable product may be configured to be capable of being incorporated into the Internet of Things (IoT) or other system of networked devices.

According to a fourth aspect of the present invention there is provided a device initialization server comprising at least one processor and memory. The server is configured, in response to receiving a first random number from an integrated circuit, to generate a signed device initialization message, the signed device initialization message comprising a device initialization message and a corresponding signature (“first signature”) built from a digest of the device initialization message, and the device initialization message comprising a copy of the random number and a device identity and to send the signed device initialization message to the integrated circuit.

The device initialization server may send the signed device initialization message directly to the device or via an intermediate device, for example a gateway, a wireless network hub or router, or a mobile communications device, such as a smart phone, at the same location as the integrated circuit. The gateway, hub, router or communications device may be in direct communication with, e.g. wired, the integrated circuit.

During device initialization, the integrated circuit may be located in an integrated circuit fabrication plant, integrated circuit packaging plant, integrated circuit test plant, transportation, warehouse or other foundry or vendor site. During device initialization, the integrated circuit may be located in an OEM-controlled site, such as an assembly plant, packaging plant, test plant, transportation or warehouse. During device initialization, the integrated circuit may be located in a sales-related site, such a shop, transportation or warehouse. During device initialization, the integrated circuit may be located in an end-customer site, such home, shop, office, factory or warehouse.

The device initialization server may comprise a crypto-processor. The device initialization server may comprise or be provided with storage. The storage may store a database of device identities. The device initialization server may be configured to draw an unused device identity and to include the unused device identity as the device identity in the device initialization message. The device initialization server may be configured to update the database that device identity has been allocated. The device initialization server may be configured to draw an unused device identity in dependence upon identity or location where device initialization takes place, for example, the identity of the fabrication, packaging or testing plant, OEM site et cetera.

The device initialization server may be configured, in response to receiving from an integrated circuit a third random number, a device identity, an identity valid value indicating that the device identity is valid, a value indicating which enableable function(s) is (are) enabled (the value may indicate that no functions are enabled) and a value indicating which disableable function(s) is (are) disabled (the value may indicate that no functions are disabled), to send a signed function enablement message to the integrated circuit, the signed function enablement message comprising a function enablement message and a signature (a “second signature”) built from a digest of the function enablement message, the function enablement message comprising a fourth random number, a purported device identity, a purported identity valid value, a functional enable value and a disable value. Thus, the device initialization sever may also be used as a feature activation server.

According to a fifth aspect of the present invention there is provided a feature activation server comprising at least one processor and memory. The server is configured, in response to receiving from an integrated circuit, a third random number, a device identity, an identity valid value indicating that the device identity is valid, a value indicating which function(s) is (are) enabled (the value may indicate that no functions are enabled) and a value indicating which function(s) is (are) disabled (the value may indicate that no functions are disabled), to send a signed function enablement message to the integrated circuit, the signed function enablement message comprising a function enablement message and a signature (a “second signature”) built from a digest of the function enablement message, the function enablement message comprising a fourth random number, a purported device identity, a purported identity valid value, a functional enable value and a disable value.

The feature activation server may send the signed function enablement message directly to the device or via an intermediate device, for example a gateway, a wireless network hub or router, or a mobile communications device, such as a smart phone, at the same location as the integrated circuit. The gateway, hub, router or communications device may be in direct communication with, e.g. wired, the integrated circuit.

According to a sixth aspect of the present invention there is provided a server for programming a general purpose portion of a one-time programmable non-volatile memory of an integrated circuit, the server comprising at least one processor and memory. The server is configured, in response to receiving from an integrated circuit, a fifth random number, a device identity, an identity valid value indicating that the device identity is valid, a value of a general purpose portion of a one-time programmable non-volatile memory, to send a signed general purpose value message to the integrated circuit, the signed general purpose value message comprising a general purpose value message and a signature (a “third signature”) built from a digest of the general purpose value message, the general purpose value message comprising a sixth random number, a purported device identity, a purported identity valid value and a general purpose value.

According to a seventh aspect of the present invention there is provided a feature deactivation server comprising at least one processor and memory. The server is configured, in response to receiving from an integrated circuit, a seventh random number, a device identity, an identity valid value indicating that the device identity is valid, a value indicating which function(s) is (are) enabled and a value indicating which function(s) is (are) disabled, to send a signed feature deactivation message to the integrated circuit, the signed feature deactivation message comprising a feature deactivation message and a signature (a “fourth signature”) built from a digest of the feature deactivation message, the feature deactivation message comprising an eighth random number, a purported device identity, a purported identity valid value, a functional enable value and a functional disable value.

According to an eighth aspect of the present invention there is provided a device initialisation system and/or a feature enablement system comprising an integrated circuit and at least one server for initializing the integrated circuit and enabling feature(s) in the integrated circuit.

The system may comprise a first server for initializing the integrated circuit and second, different server for enabling feature(s) in the integrated circuit. The first and second server are preferably provided with a common database which stores at least a plurality of device identities and, optionally, for each device identity, a set of one or more enabled functions.

A first key pair can be used for device initialization and a second, different key pair can be used for feature activation. More than one set of different key pairs can be used for feature activation. A third key pair or a third set of key pairs may be used for programming general purpose fuses. A fourth key pair or a fourth set of key pairs may be used for programming disable fuses.

### BRIEF DESCRIPTION OF THE DRAWINGS

Certain embodiments of the present invention will now be described, by way of example, with reference to the accompanying drawings, in which:

FIG. 1 is a schematic block diagram of an integrated circuit, which includes a one-time programmable non-volatile memory and a memory controller for the one-time programmable non-volatile memory, and a trusted server;

FIG. 2 is a process flow diagram of a method of initializing a device identity;

FIGS. 3a to 3d illustrates steps during device identity initialization;

FIG. 4 is a process flow diagram of a method of enabling functions in a device;

FIGS. 5a to 5d illustrates steps during function enablement;

FIGS. 6a and 6b are schematic block diagrams of first and second arrangements for connecting an integrated circuit to a trusted server;

FIG. 7 illustrates an industrial system which includes at least one integrated circuit which has been initialized and enabled; and

FIG. 8 illustrates a motor vehicle which includes integrated circuits which have been initialized and enabled.

### DETAILED DESCRIPTION OF CERTAIN EMBODIMENTS

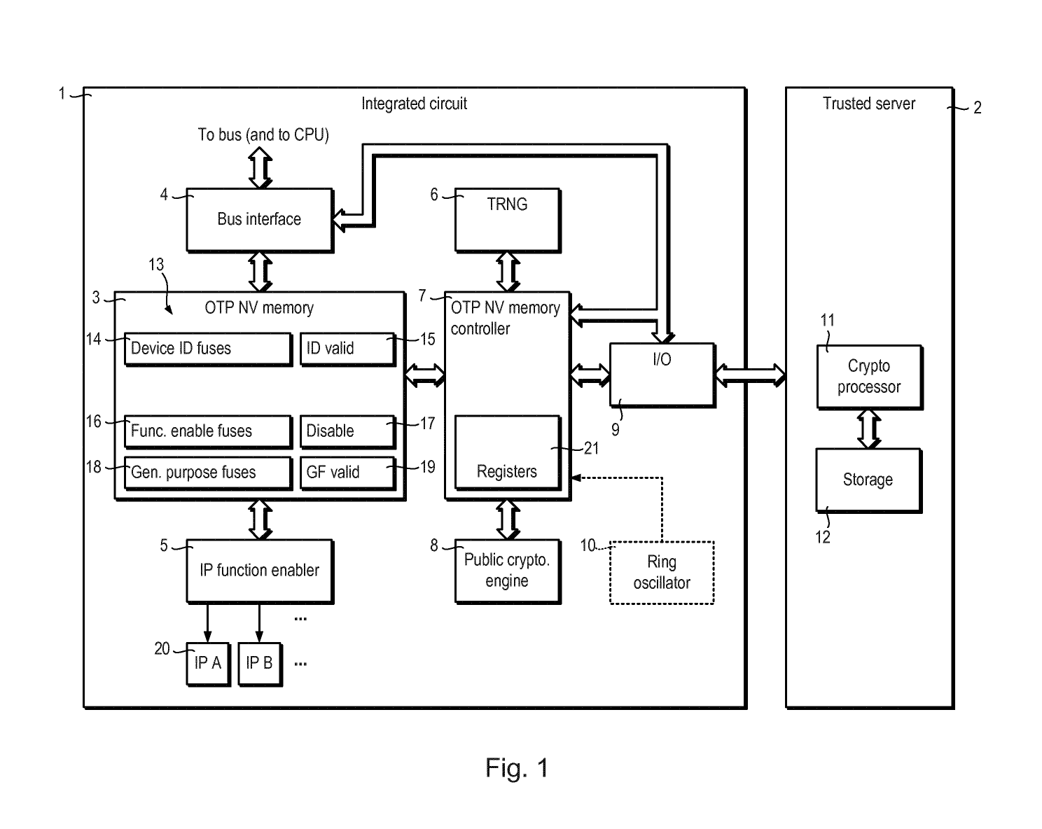

FIG. 1 shows an integrated circuit 1 (herein also referred to as a “semiconductor device” or simply “device”) and a remotely-located (or “external”) trusted server 2. The integrated circuit 1 can take the form of any featurizable integrated circuit, such as, for example, a microcontroller or a system-on-a-chip. The integrated circuit 1 and trusted server 2 may communicate via an optional communications device (not shown), such as mobile communications device.

### Integrated Circuit 1

After fabrication, the integrated circuit 1 has a limited set of features (herein also referred to as “functions”), as described, for example in WO 2015/124673 A1 which is incorporated herein by reference. The integrated circuit 1, however, can be activated by the trusted server 2 based on programming a unique identity into an on-chip, one-time programmable non-volatile memory 3 using an asymmetric cryptographic process and, thereafter, selectively enabling functions based on the unique identity.

As will be explained in more detail hereinafter, the integrated circuit 1 only initiates the process of programming the one-time programmable non-volatile memory 3 once it has validated a signature which takes the form of a plaintext message that has been generated by the trusted server 2. As validation of the signature is based on public cryptography using a public key hardwired into the device 1, there is no private key or secret data stored in the device 1 that can be stolen and copied.

Referring to FIG. 1, the integrated circuit 1 includes a one-time programmable (OTP) non-volatile (NV) memory 3, an internal bus interface 4, an intellectual property (IP) function enabler 5, a true random number generator (TRNG) 6, an OTP NV memory controller 7 (herein also referred to as “fuse ROM controller”), a public cryptographic engine 8, an input/output (I/O) interface 9 and an optional ring oscillator 10. The integrated circuit 1 may comprise other elements, such as one or more central processing units, bus system, volatile memory, non-volatile memory, general input/output modules, communication controllers and other peripheral modules, but which are omitted to aid clarity.

The trusted server 2 takes the form of a general-purpose computer system comprising at least one central processing unit (not shown), memory (not shown) and a network interface module (not shown). The trusted server 2 may include a crypto-processor 11 and/or may include suitable security modules, such as a hardware security module (HSM). The trusted server 2 includes, or has access to, storage 12 for storing device identities.

The one-time programmable non-volatile memory 3 takes the form of fuse read-only memory 3 (or “fuse ROM”). However, anti-fuse read-only memory or other similar types of write-once, read-many-times non-volatile memory may be used. The one-time programmable non-volatile memory 3 includes sets 13 of fuses (herein also referred to as “fields” or “parts of memory”) or other one-time programmable non-volatile memory elements which can be programmed and used to permanently store data. Herein, for brevity, the term “fuse” may be used to refer to a one-time programmable non-volatile memory element and the term “fuse ROM” may be used to refer to the one-time programmable non-volatile memory. Also, the term “blowing” may be used to refer to programming a one-time programmable non-volatile memory. The fuse fields 13 include a field 14 for storing a unique identity of the integrated circuit, a field 15 for indicating whether the device identity field is valid, function enable fuses 16 for enabling device functionality, disable fuse(s) 17 which may be used to disable one or more device functionalities permanently, a field 18 of general purpose fuses and a fuse valid field 19 for indicating whether the corresponding general purpose fuses are valid.

Permanently disabling functions may be used at the end of the life of the integrated circuit or in cases where a particular function, for example a crypto function, should not be enabled, for example, due to export control.

The number of device identity fuses 14 is sufficiently large to store a unique identity number for each integrated circuit 1 and, optionally, to encode other information, such as factory identity, OEM identity, date of production et cetera. For example, there may be at least 32 and up to 128 or more device identity fuses 16.

The device identity valid field 15 comprises one fuse. However, there may be more than one fuse, e.g. three fuses, for example, to provide redundancy.

The number of function enable fuses 16 is sufficiently large for the number of functions which can be controllably enabled. For example, there may be at least four and up to 128 or more function enable fuses 16. The number of fuses may be increased (for example, tripled) to provide redundancy.

The set of disable fuses 17 may comprise one or more fuses. For example, a single fuse can be used to disable all controllably-enablable functions which, for instance, can be employed at the end of the life of the integrated circuit 1. Additionally or alternatively, a fuse can be provided for each controllably-enablable function such that, once programmed, the function is permanently and irrevocably disabled. This can be used to help to provide further protection against illicit function enablement. Additionally or alternatively, this may be used for integrated circuits which are marketed in more than one country, but which have functions (such as crypto functions) which are banned in certain countries.

The number of general purpose fuses 18 can be zero, one or more than one. In some cases, there may be a few thousand general purpose fuses 18.

The number of general purpose valid fuses 19 can be one or more than one. For example, one fuse 19 for all the general purpose fuses 18. Alternatively, there may a fuse 19 for a set of the general purpose fuses 18 and/or a fuse 19 for each general purpose fuse 18.

The internal bus interface 4 can take the form of an Advanced Microcontroller Bus (AMB) or other suitable on-chip bus system for allowing a central processing unit (CPU) or other processor or module to read the states of the fuses 13 or some of the fuses 13.

Dependent on the function enable fuses 16, the disable fuse 17 and the general purpose valid fuses 19, the IP function enabler 5 provides enable signals for enabling functionality of one or more IP units 20.

The true random number generator 6 (herein referred to simply as the “random number generator”) is able to deliver a true random number to the OTP NV memory controller 7. The random number is sufficiently long, for example, to resist replay attacks. The random number generator 6 is capable of generating random numbers which are between 64 and 512-bits long or even longer.

The OTP NV memory controller 7 (herein also referred to as a “fuse ROM controller” or “fuse controller”) takes the form of hardware logic, which implements a finite-state machine, or a CPU sub-system. The OTP NV memory controller 7 handles reading and writing (or “programming”) of fuses 13 in the fuse ROM 3, requesting random numbers from the true random number generator 6 and requesting signature verification of a message received via the input/output interface 9 from the true random number generator 6. The OTP NV memory controller 7 includes a set of internal registers 21.

The public cryptographic engine 8 (herein referred to simply as the “cryptographic engine”) is based on asymmetric cryptography. It is able to build a digest of a message. Furthermore, it is able to verify the signature of a message digest based on a set of device internal public keys, namely a device identity public key DID_{PB}, a general purpose public key GP_{PB}, a feature enable public key FE_{PB} and a disable public key D_{PB}. The cryptographic engine 8 is controlled by the OTP NV memory controller 7.

The input/output interface 9 allows the integrated circuit 1 to exchange data streams with an external device, in particular, the trusted server 2 during device initialization and feature enablement. The input/output interface 9 can provide a direct interface to the server, for example an Ethernet controller, or could be any form of I/O interface to a gateway controller, such as a serial interface to a computer, or a Bluetooth® or USB connection to a smartphone.

The input/output interface 9 may be connected to the bus interface 4. Thus, messages from the trusted server 2 can be transmitted to the OTP NV memory controller 7 either via the input/output interface 9 or via the input/output interface 9, bus interface 4 and CPU (not shown).

The ring oscillator 10 may provide a trusted clock, for example, to provide a clock signal to the memory controller 7 and so avoid the use of over-clocking or other timing-based ways of attacking the system.

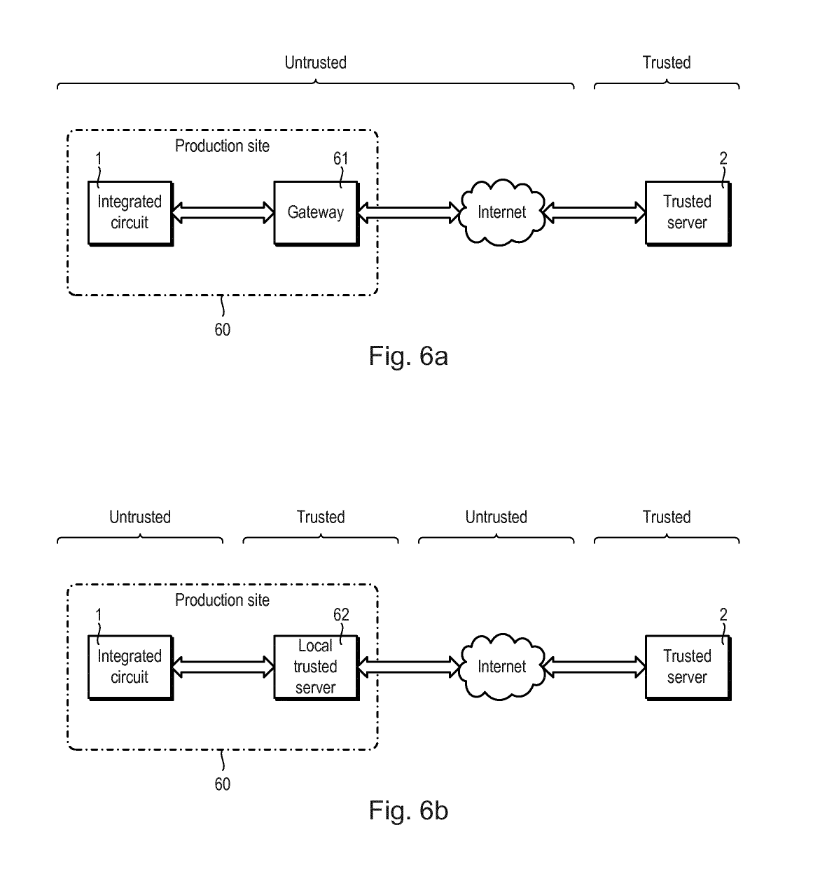

A semiconductor fabrication plant 60 (FIGS. 6a and 6b) manufactures the integrated circuit 1 (which is one of many) with the fuses 13 not yet programmed, i.e. unblown. As long as the function enable fuses 16 and ID valid fuse 15 are not blown, some or all of the features 20 are blocked by the function enabler 5.

A process of featurization will now be described. Featurization generally comprises two stages, namely a device identity initialization stage and a feature enabling stage.

### Device Identity Initialization

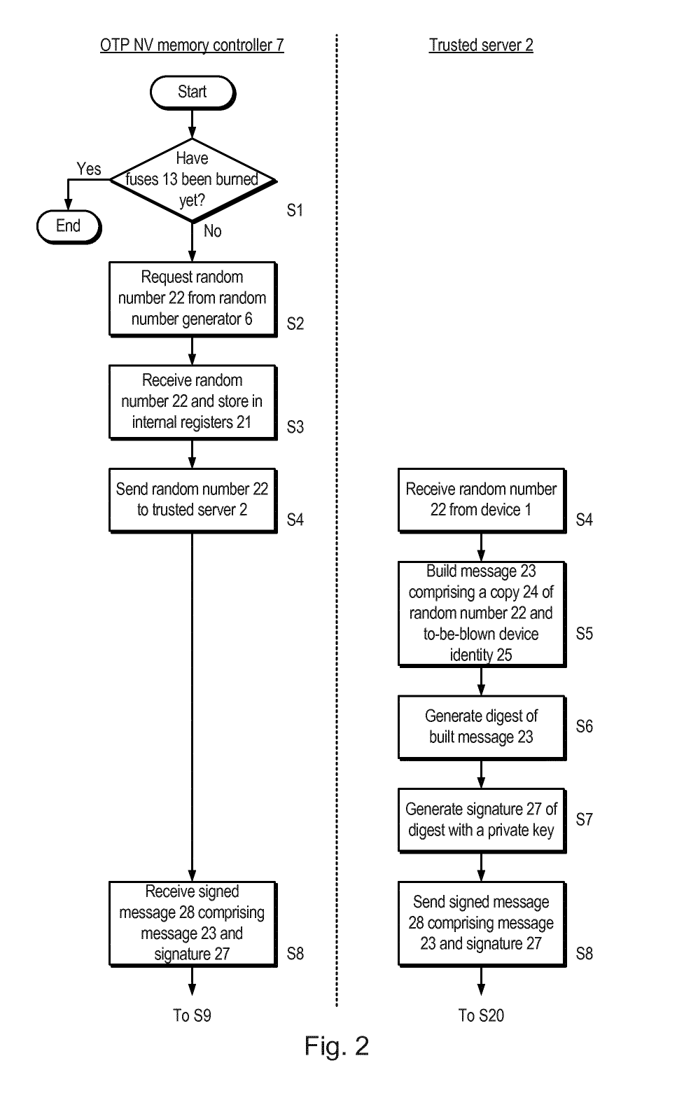

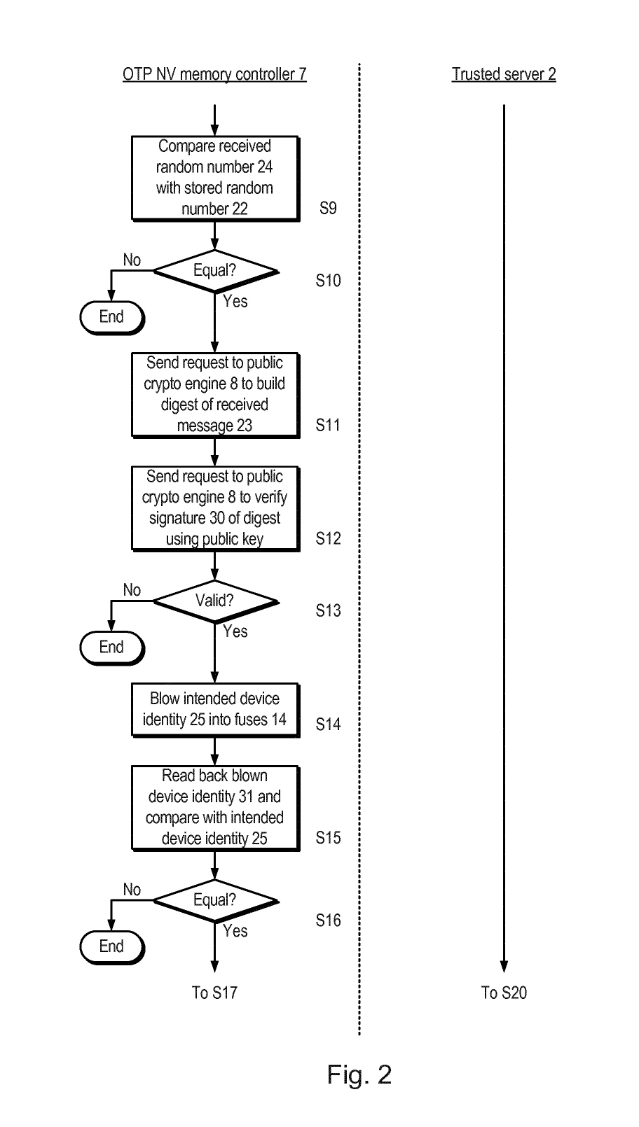

FIG. 2 is a process flow diagram of a method of device identity initialization.

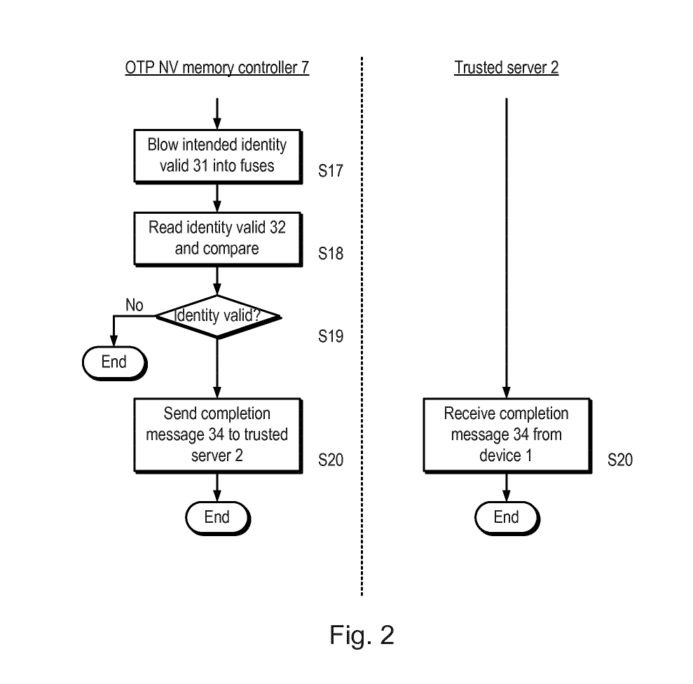

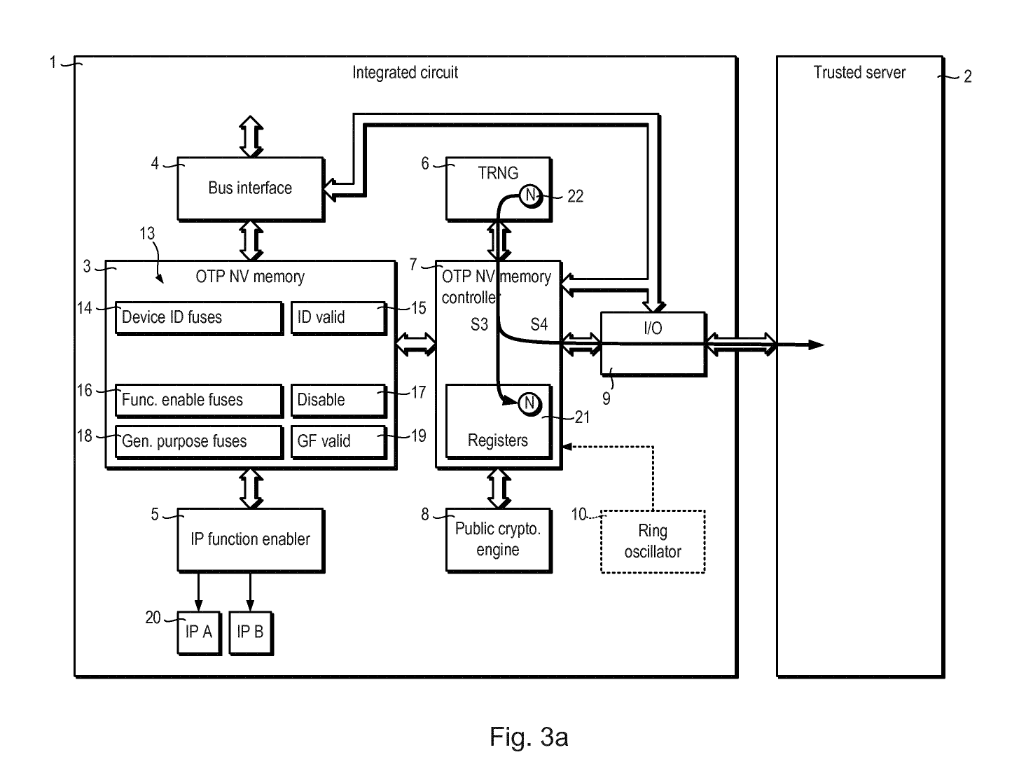

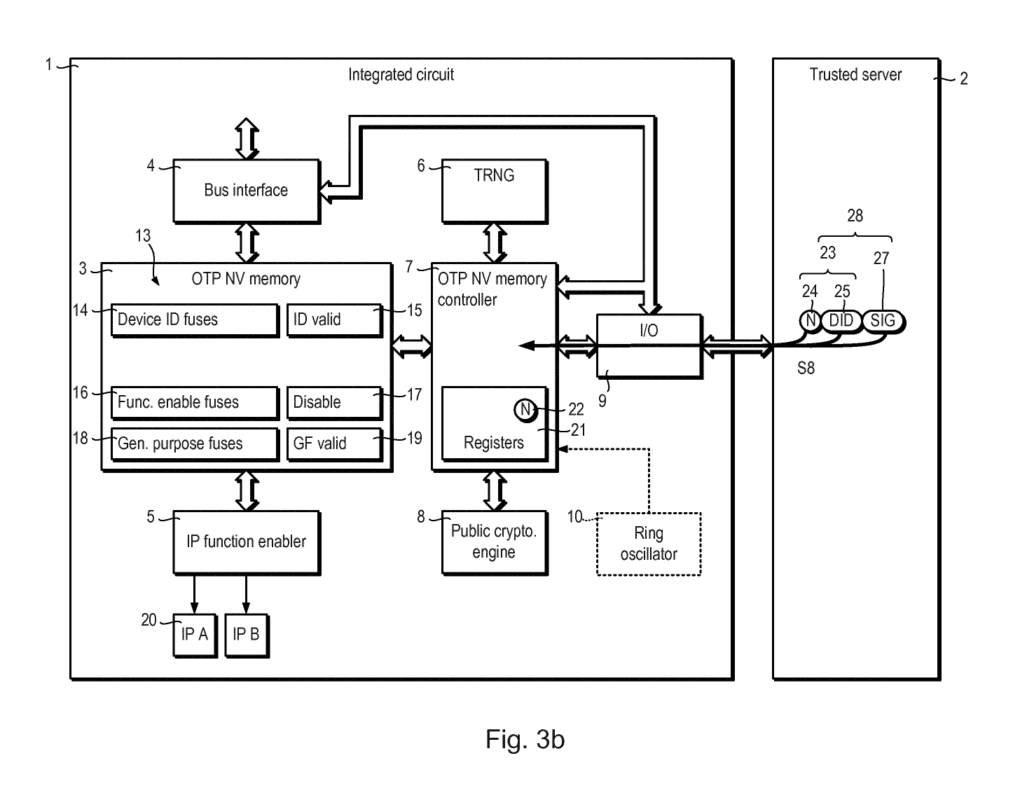

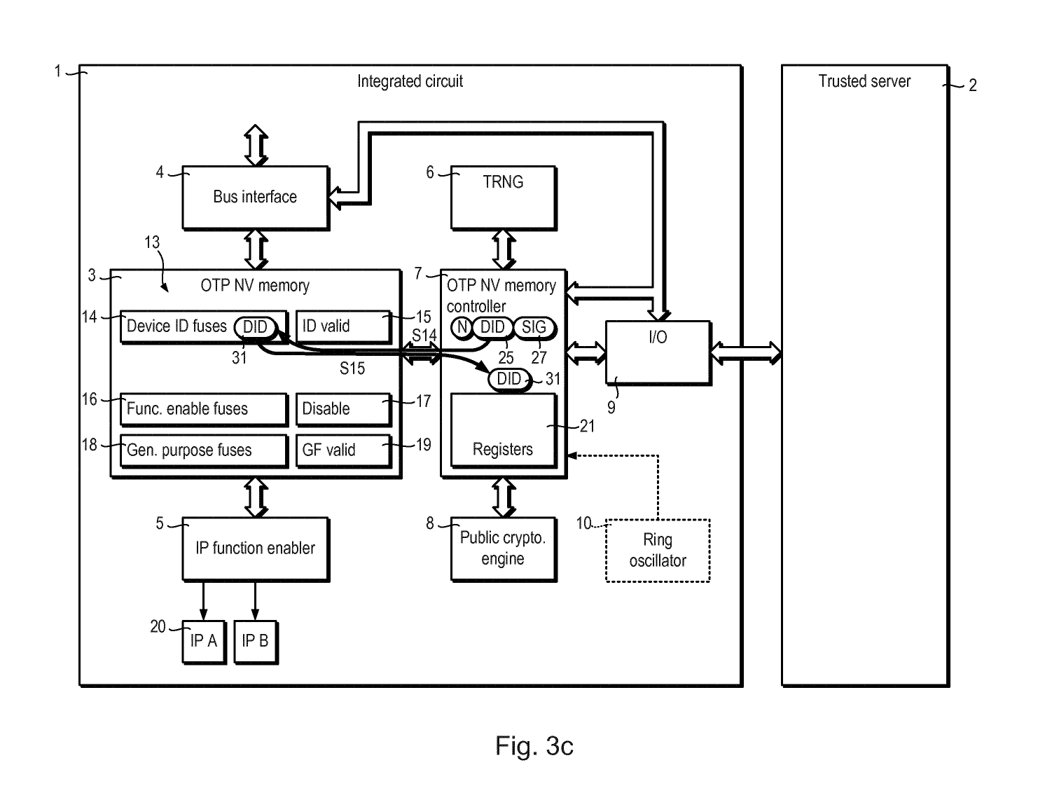

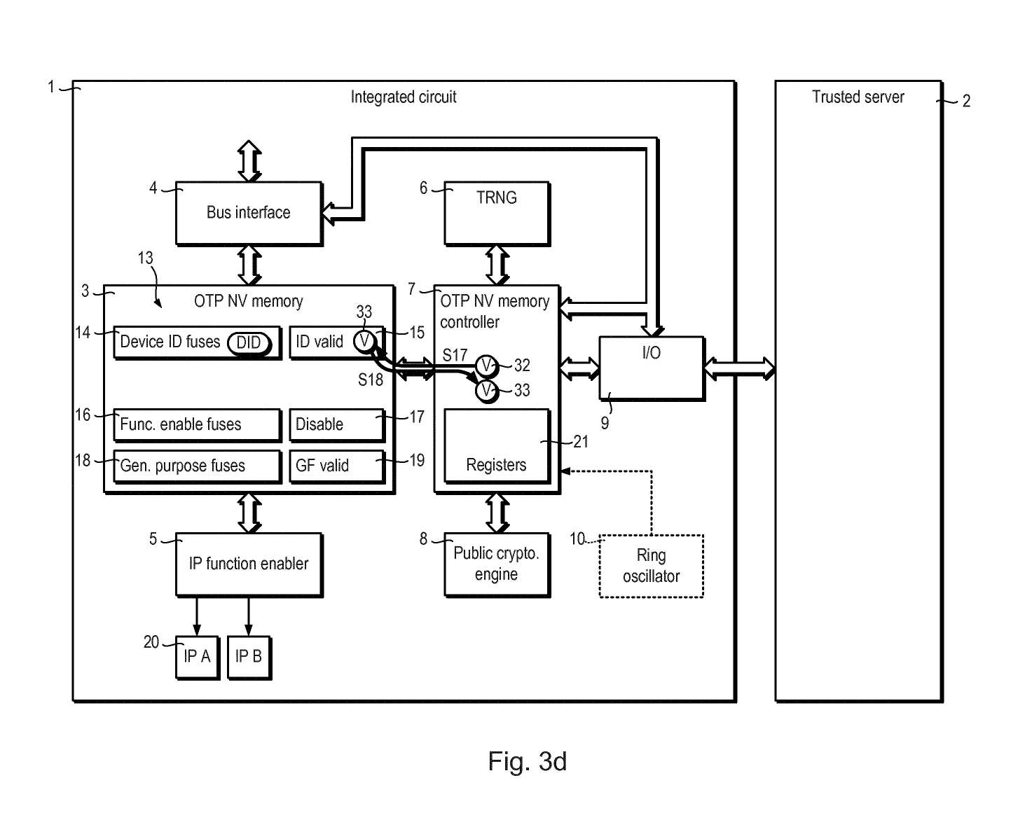

Referring to FIGS. 2 and 3a, when operations start, the OTP NV memory controller 7 verifies that no fuses 13 have yet been programmed (step S1). If the OTP NV memory controller 7 determines that no fuses 13 have yet been programmed, it requests a first random number 22 from the random number generator 6 (step S2) and stores it in an internal registers 21 (step S3). The OTP NV memory controller 7 sends the first random number 22 to the trusted server 2 which is outside the device 1, i.e. off chip (step S4).

Referring to FIGS. 2 and 3b, the trusted server 2 builds a message 23 comprising a copy 24 of the random number 22 and a to-be-blown device identity 25 (step S5). The trusted server 2 generates a digest (not shown) of the built message 23 (step S6) and a signature 27 of the digest (not shown) using a private key DID_{PR} (step S7). The trusted server 2 transmits a package 28 comprising the message 23 and the signature 27 to the OTP NV memory controller 7 (step S8).

The OTP NV memory controller compares the received copy 24 of the random number 22 with the random number 22 stored in its internal registers 21 (step S9 & S10). If the two random numbers 22, 24 are not equal, then the OTP NV memory controller 7 stops the initialization process. If the two random numbers match, then the OTP NV memory controller 7 requests the public cryptography engine 8 to build a digest (not shown) of the received random number 24 and the to-be-blown device identity 25 (step S11).

The OTP NV memory controller 7 requests the cryptography engine 8 to verify the signature 27 of the locally-generated digest (not shown) with using the public key DID_{PB} (step S12 & S13). If the signature 27 of the locally-generated digest (not shown) is not valid, then it stops the initialization process.

Referring to FIGS. 2 and 3c, the OTP NV memory controller 7 blows the intended device identity 25 into the device identity field 14. The OTP NV memory controller 7 reads back the device identity 31 stored in the blown device identity fuses 14 and compares this with the intended device identity 25 (step S15 & 16). If the blown device identity 31 and the intended device identity 25 differ, then the OTP NV memory controller 7 stops initialization.

Referring to FIGS. 2 and 3d, in case the blown device identity 31 matches the intended device identity 25, the OTP NV memory controller 7 blows the identity valid fuse 15 with value 32 (step S17). The OTP NV memory controller 7 reads back a value 33 of the identity valid fuse 15 and inspects the value 33 (steps S18 & 19). If the fuse 15 is blown, then then the OTP NV memory controller 7 sends a message 34 to the trusted server 2 informing it that the device identity initialization process has been successfully completed (step S20).

Each device identity 25 is unique and may indicate the identity of the production site 60 (FIGS. 6a and 6b). The trusted server 2 maintains a database (not shown) of device identities even if devices 1 are fabricated across more than one production site 60 (FIGS. 6a and 6b). Depending on need, the device identity 25 may be programmed at any one of several locations, such as at the fabrication plant (or “fab”), packaging or testing site, a sorting plant, an original equipment manufacturer (OEM) production site or a final customer site.

### Function Enablement

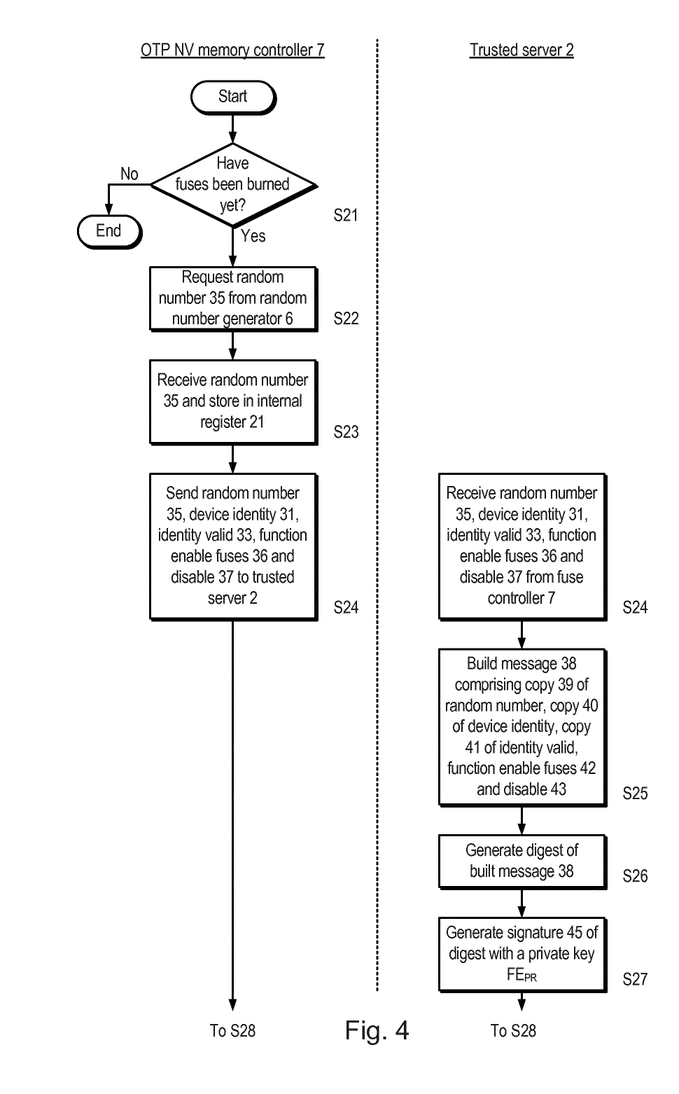

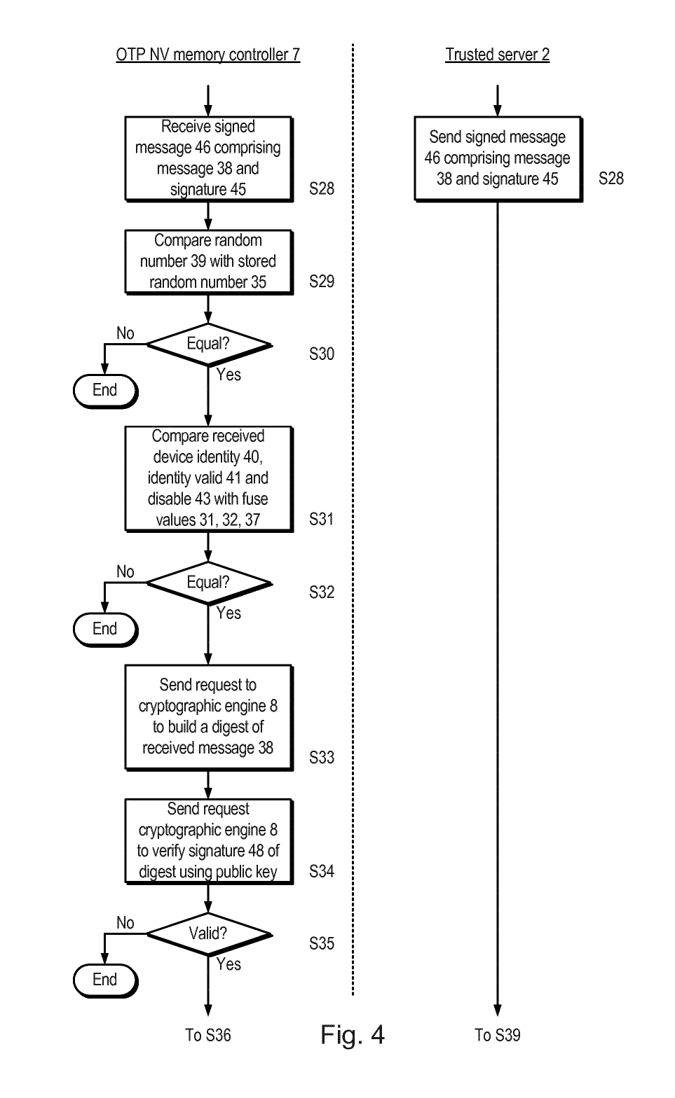

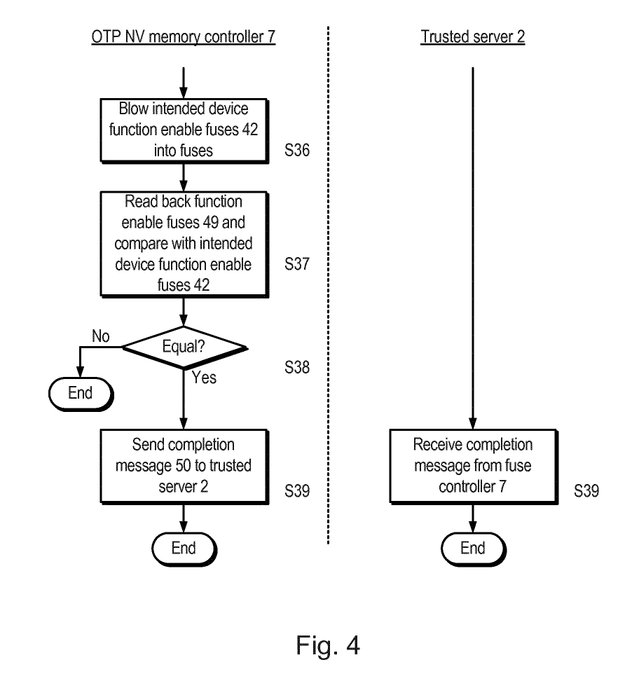

FIG. 4 is a process flow diagram of a method of enabling functions (herein also referred to as “features”) in a device 1 that has been initialized. Function enablement can be carried out more than once, each time initializing one or more new features.

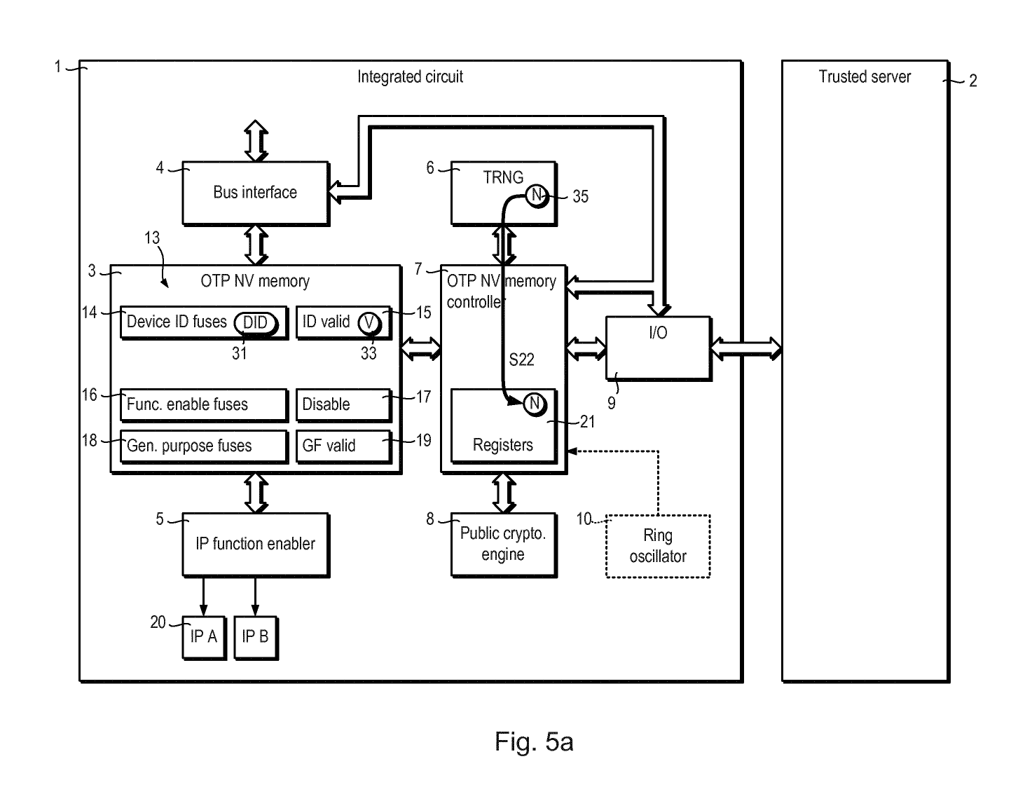

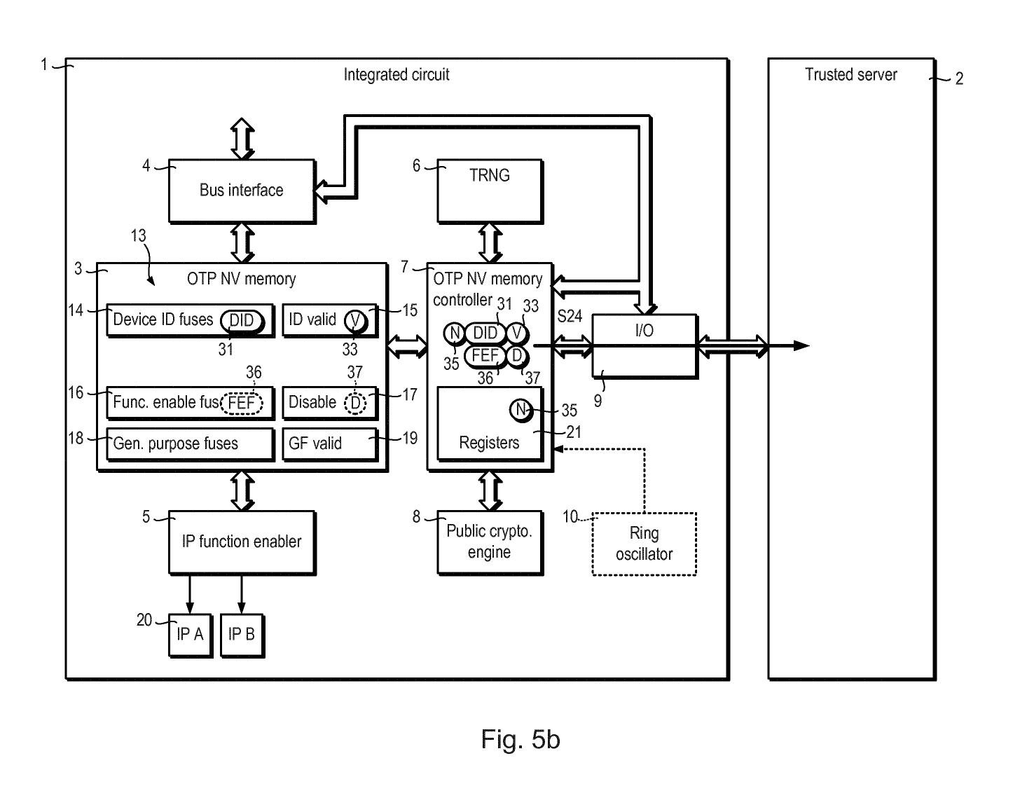

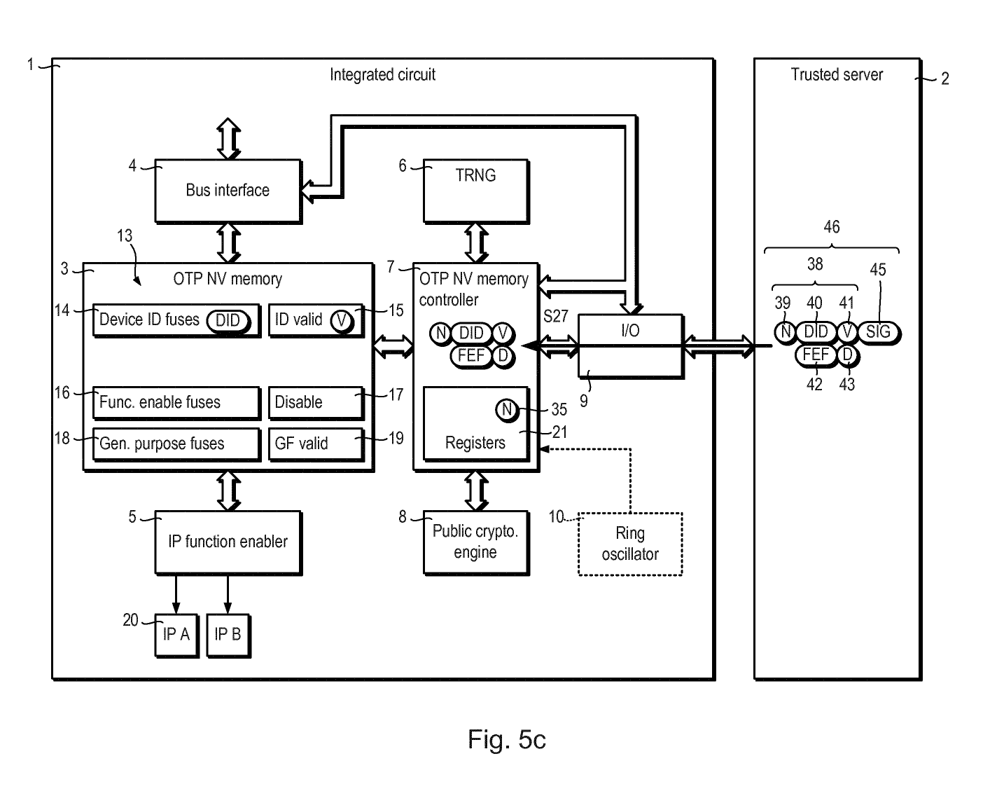

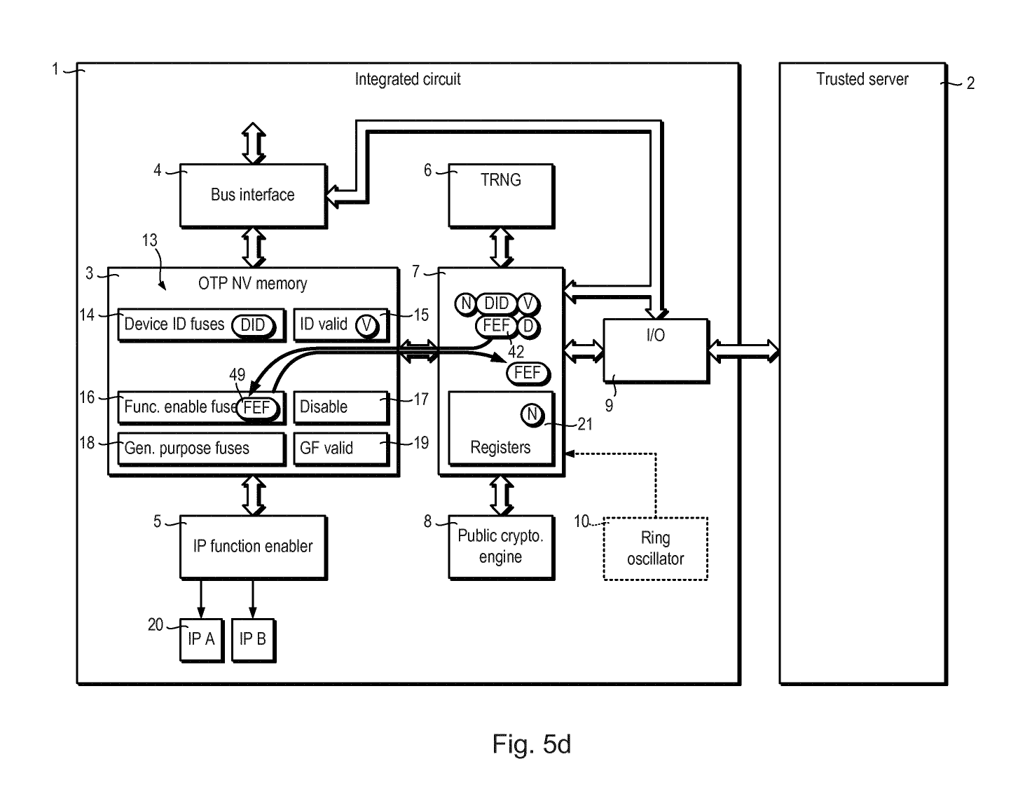

Referring to FIGS. 4 and 5a, the OTP NV memory controller 7 verifies that the device identity fuses 14 contain an identity and that the identity valid fuse 15 has been burned (step S21). If the device identity fuses 14 are blank and/or the identity valid fuse 15 has not been blown, then the OTP NV memory controller 7 stops the feature enabling process.

The OTP NV memory controller 7 requests a second random number 35 from the random number generator 6 and stores the number 35 in internal registers 21 (steps S22 & 23).

Referring to FIGS. 4 and 5b, the OTP NV memory controller 7 sends the random number 35, the device identity 31, the identity valid value 33, value(s) 36 stored in the function enable fuses 16 and value(s) 37 stored disable field 17 to the trusted server 2 (step S24).

The function enable fuses 16 and disable fuses 17 may store values 36,37 which are virgin or which have been written from a previous rounds of function enablement.

Referring to FIGS. 4 and 5c, the trusted server 2 builds a second message 38 consisting of a copy 39 of the received random number 35, a copy 40 of the received device identity 31, a copy 41 of the identity valid value 33, the to-be-blown function enable fuses 42 and a copy of the value(s) 37 stored in the disable field 37 (step S25). The trusted server 2 builds a digest (not shown) of the built message 38 (step S26) and generates a signature 45 of the digest (not shown) using a private key FE_{PR} (step S27). The trusted server 2 sends back a package 46 with the message 38 and the signature 45.

A similar process can be used for disabling functions. In that case, the trusted server 2 builds a second message 38 consisting of a copy 39 of the received random number 35, a copy 40 of the received device identity 31, a copy 41 of the identity valid value 33, a copy of the value(s) 36 stored in function enable fuses 42 and the to-be-blown disable value 43.

The OTP NV memory controller 7 compares the received random number 39 with the stored random number 35 (steps S29 & S30). If the numbers 35, 39 are not equal, then the fuse controller 7 stops the feature enabling process.

The OTP NV memory controller 7 compares the received device identity 40, the received valid value 41, the received disable value 43 with values 31,33,37 (steps S31 & S32). If they differ, then the OTP NV memory controller 7 stops the feature enabling process.

The OTP NV memory controller 7 requests the cryptographic engine 8 to build a digest (not shown) of the received message 38 (step S33) and requests the cryptographic engine 8 to verify the signature 45 of the digest (not shown) with the public key FE_{PB} (steps S34 & S35). If the signatures 45 is not valid, then the OTP NV memory controller 7 stops the feature enabling process.

Referring to FIGS. 4 and 5d, the OTP NV memory controller 7 blows the function enable 42 into the fuses 16 (step S36). The OTP NV memory controller 7 reads back the value 49 stored in the blown fuses 16 and compares this with the value of the intended fuse enable value 42 (steps S37 & S38). If the values are the same, then the OTP NV memory controller 7 sends a message 50 informing the trusted server 2 that feature enabling process has been successfully completed (step S39). The trusted server 2 updates its database (not shown) to record the functions or the additional functions that are enabled in the device 1.

The function enable fuses 16 do not have a corresponding valid fuse. Feature enabling process may be repeated and a resulting function set is the disjunction of enabled functions. This can allow upgrading of functionality at different locations in production.

### Function Disablement

Disable purpose fuses 17 can be programmed in a similar way to programming function enable fuses 16 using a disable key pair D_{PR}/D_{PB}.

General Purpose Fusing

General purpose fuses 18 can be blown in a similar way to the device identity 14 and function enable fuses 16 using a general purpose key pair GP_{PR}/GP_{PB}.

General purpose fuses 18 can be used for a number of different purposes. For example, general purpose fuses 18 allow an OEM to blow an OEM-specific information or data, such as a public key into the device 1. General purpose fuses 18 can also be used to blow trim values (or “trimmings”) into the device 1. General purpose fuses 18 could be also used to store production test logs into the device, such as the x-y position of the device in the wafer.

### Trusted Server

Referring to FIG. 6a, a first arrangement for operating the integrated circuit 1 and trusted server 2 is shown. The first arrangement is generally intended to be used when the integrated circuit 1 and trusted server 2 are able to communicate on-line.

The trusted server 2 is operated by a vendor, i.e. the entity that has the authority to produce the integrated circuit 1, such as Renesas Electronics Corporation®. The vendor outsources fabrication or other production activity, such as packaging, to another entity that operates a production or other type of site 60.

A gateway 61 is located at the production site 60 which provides an interface between the integrated circuit 1 and the trusted server 2. The gateway 61 connects and, optionally authenticates, the device 1 with the trusted server 2 and forwards traffic between the integrated circuit 1 and the trusted server 2. In this arrangement, only the trusted server 2 signs messages and keeps private keys. This can help to maximise security.

Referring to FIG. 6b, a second arrangement for operating the integrated circuit 1 and trusted server 2 is shown. The second arrangement can be used even when the integrated circuit 1 and trusted server 2 are off-line, i.e. not always in communication.

Similar to the first arrangement, the trusted server 2 is operated by a vendor and the vendor outsources fabrication or other production activity to another entity that operates a production site 60.

A local trusted server 62 is located at the production site 60. The local trusted server 62 is authorised to initialise a predefined number or set of integrated devices 1 using pre-allocated device identities. In this arrangement, the local trusted server 62 is able to sign messages.

### Keys

Using different public keys for blowing and validating the device identity fuses, general purpose fuses and function enable fuses can help to provide flexibility in the configuration and functionality of the trusted servers 2 and local trusted servers 62.

For example, a single trusted server 2 can be used to program all the fuses. Alternatively, a trusted server 2 may be used to handle device identity initialization and one more other trusted servers 2 may be used to handle enabling of functions.

Moreover, other trusted servers 2, namely feature deactivation servers or device deactivation servers, may be used to handle deactivation of features or devices.

Using more than one server and allocating different roles to the servers 2, especially if different set of keys are used at different stages, can help to increase security.

### Secure Content Fusing

Referring again to FIG. 1, the general purpose fuses 18 can be used to store secure content (not shown). In particular, if the production site 60 (FIG. 6a) is considered to be untrustworthy, then the general purpose fuses 61 can be blown after fabrication, for example, at an original equipment manufacturer (OEM) site.

### Counterfeit Protection

The arrangement and approach herein described can help to reduce or prevent counterfeiting arising a result of fabricating or handling integrated circuits at an untrusted production sites. Production sites which are not trusted send requests to the trusted server(s) for device identities. Replay attacks of the untrusted production sites do not work provided generation of random numbers by the integrated circuit 1 are not influenced.

Random Number Generation

Any random number generated by the integrated circuit l should be truly random and should be able to withstand side channel attacks.

The integrated circuit 1 should be configured such that fuse blowing is not possible in a test or scan mode.

Semiconductor devices can operate in a scan mode. The scan mode is used to ensure that the devices are produced as intended. In scan mode, all registers of a device are arranged in a chain. Test equipment (not shown) preloads the chain and executes, for example, one clock cycle of functional mode. The test equipment then reads out and empties the scan chain and determines whether the one clock cycle of functional mode has operated successfully by comparing a reference functional output against the shifted out scan values (i.e. flip-flop contents).

This mode can offer an attacker the possibility to bypass sequential operations of state machines. The attacker could preload the device state machines with any content and executes one or more functional cycles. For example, they could preload the fuse ROM controller 7 with content indicating that random numbers match and that the signature is valid (step S13; FIG. 2) and blow an identity into fuses 14 (step S14; FIG. 2). The attacker might then load the state (step S16; FIG. 2) and blow the identity valid fuse 31 (step S17; FIG. 2).

However, by suppressing fusing in scan mode, this type of attack can be prevented.

A sufficiently long random number should be used to guard against an untrusted production site recording device identity activation patterns and attempting replay attacks possible.

Even if device features are not enabled, they can be testable in a fabrication plant. For example, beside scan tests, devices are sometimes operated in function test mode in order to achieve higher coverage. There might be a special test mode that enables the features of the device in a way that is not relevant for normal operation. For example, in test mode, a feature can be enabled independently of the fuse setting, but with a very limited amount of CPU memory. The limited CPU memory would not be enough to build a real application, but would be enough to test the features functionality.

### Message Signing Implementations

An existing signing algorithm or an elliptic curve digital signature algorithm (ECDSA) can be used for signing messages. An ECDSA implantation is efficient from the point of view of memory requirement since the key length is small compared to conventional existing signing algorithms.

### Use of Integrated Circuits

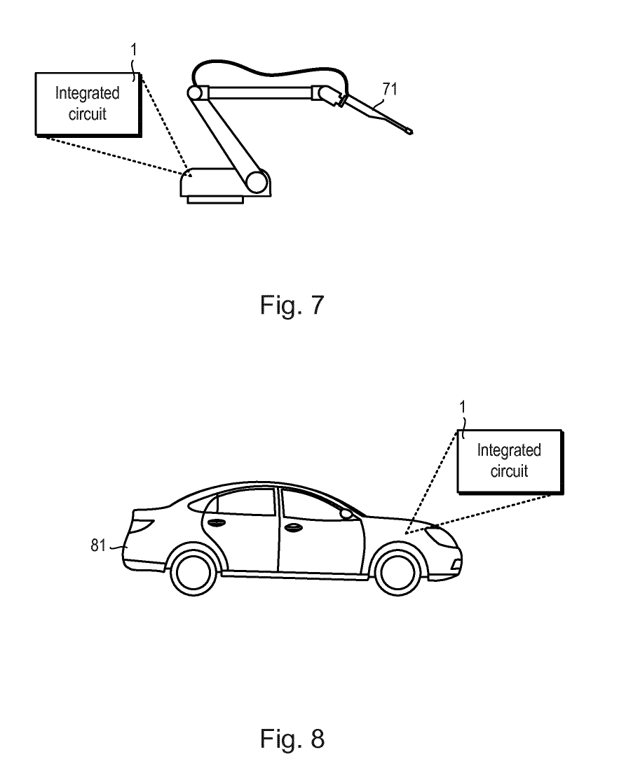

Referring to FIG. 7, one or more integrated circuits 1 (which, if there are plurality of integrated circuits, need not be the same) may be used in an industrial system 71, such as a robot, electricity meter or smart card reader, found in an industrial plant (not shown).

Referring also to FIG. 8, a plurality of integrated circuits 1 (which need not be the same) may be used in a motor vehicle 81.

As explained earlier, features in an integrated circuit 1 need not necessarily be enabled at time of fabrication, but can be enabled after it has been incorporated into an assembled system 71, 81.

Feature enablement in-situ can help to minimise (and even prevent) the use of counterfeit integrated circuits since feature enablement can be more tightly controlled. Moreover, feature enablement can make it more difficult for counterfeit products to be made and successfully marketed since it is harder for a counterfeit manufacture OEM to obtain and activate integrated circuits with the necessary functions enabled.

It will be appreciated that many modifications may be made to the embodiments hereinbefore described.

1. An integrated circuit comprising:
a one-time programmable non-volatile memory; and
a memory controller for the one-time programmable non-volatile memory;
the memory controller configured:
to send a first random number which has been generated in the integrated circuit to a device initialization server; and
in response to receiving a signed device initialization message from the device initialization server, the signed device initialization message comprising a device initialization message and a signature, and the device initialization message comprising a second random number and a device identity;
to determine whether the first and second random numbers are equal and whether the signature is valid; and
in response to determining that the first and second random numbers are equal and that the signature is valid:
to program the device identity into a first part of the one-time programmable non-volatile memory.

2. An integrated circuit according to claim 1, wherein the memory controller is further configured:
to read a device identity from the first part of the one-time programmable non-volatile memory;
to determine whether the device identity read from the first part of the one-time programmable non-volatile memory and the device identity programmed into the first part of the one-time programmable non-volatile memory are equal; and
in response to determining that the device identities are equal:
to program an identity valid value into a second part of the one-time programmable non-volatile memory.

3. An integrated circuit according to claim 2, wherein the memory controller is further configured:
to read an identity valid value from the second part of the one-time programmable non-volatile memory;
to determine whether the identity valid value read from the second part of the one-time programmable non-volatile memory and the identity valid value programmed into the second part of the one-time programmable non-volatile memory are equal; and
in response to determining that the identity valid values are equal:
to send a message to the device initialization server for confirming that device initiation has been completed.

4. An integrated circuit according to claim 1, further comprising:
a random number generator configured to generate a random number and to provide the random number to the memory controller.

5. An integrated circuit according to claim 1, further comprising:
a public cryptographic engine configured, in response to receiving data from the memory controller which includes a signature, to verify the signature.

6. An integrated circuit according to claim 1, further comprising:
a function enabler configured, in dependence upon values in the one-time programmable non-volatile memory to enable one or more functions.

7. An integrated circuit according to claim 1, wherein the one-time programmable non-volatile memory further comprises:
a third part for storing a value indicating which enableable function(s) of the integrated circuit is (are) enabled; and
a fourth part for storing a value indicating which disableable function(s) of the integrated circuit is (are) disabled.

8. An integrated circuit according to claim 7, wherein the memory controller is configured:
to send a third random number which has been generated in the integrated circuit to a feature enablement server and content of the first, second, third and fourth parts of the one-time programmable memory; and
in response to receiving a signed function enablement message from the feature enablement server, the signed function enablement message comprising a function enablement message and a signature, the function enablement message comprising a fourth random number, a purported device identity, a purported identity valid value, a function enable value and a disable value:
to determine whether the third and fourth random numbers are equal and whether the signature is valid; and
in response to determining the third and fourth random number are equal and that the signature is valid:
to program the function enable value in the third part of the one-time programmable non-volatile memory.

9. An integrated circuit according to claim 7, wherein the memory controller is configured:
to send a fifth random number which has been generated in the integrated circuit to a feature disablement server and content of the first, second, third and fourth parts of the one-time programmable memory; and
in response to receiving a signed function disablement message from a feature disablement server, the signed feature disablement message comprising a feature disablement message and a signature, the feature disablement message comprising a sixth random number, a purported device identity, a purported identity valid value, a function enable value and a disable value:
to determine whether the fifth and sixth random numbers are equal and whether the signature is valid; and
in response to determining the fifth and sixth random numbers are equal and that the signature is valid:
to program the disable value in the fourth part of the one-time programmable non-volatile memory.

10. An integrated circuit according to claim 1, wherein the one-time programmable non-volatile memory further comprises:
a fifth part for storing a value for a user-defined purpose;
wherein the memory controller is configured:
to send a seventh random number which has been generated in the integrated circuit to a user server and content of the fifth part of the one-time programmable memory; and
in response to receiving a signed user-defined message from the user server, the signed user-defined message comprising a user-defined message and a signature, the user-defined message comprising an eighth random number, a purported device identity, a purported identity valid value and a user-defined value:
to determine whether the seventh and eighth random numbers are equal and whether the signature is valid; and
in response to determining the seventh and eighth numbers are equal and that the signature is valid:
to program the user-defined value in the fifth part of the one-time programmable non-volatile memory.

11. An integrated circuit according to claim 1, which is a digital integrated circuit.

12. An integrated circuit according to claim 1, which is a mixed-signal integrated circuit.

13. An integrated circuit according to claim 1, which includes non-volatile random-access memory.

14. An integrated circuit according to claim 1, which is a microcontroller or a system-on-a-chip.

15. An industrial system or motor vehicle which includes at least one integrated circuit according to claim 1.

16. A server comprising:
at least one processor; and
memory;
the server is configured, in response to receiving a first random number from a integrated circuit:
to generate a signed device initialization message, the signed device initialization message comprising a device initialization message and a corresponding signature, and the device initialization message comprising a copy of the random number and a device identity; and
to send the signed device initialization message to the integrated circuit.

17. A server according to claim 16, wherein the server is configured, in response to receiving from an integrated circuit:
a third random number;
a device identity;
an identity valid value indicating that the device identity is valid;
a value indicating which enableable function(s) of the integrated circuit is (are) enabled; and
a value indicating which disableable function(s) of the integrated circuit is (are) disabled;
to send a signed function enablement message to the integrated circuit, the signed function enablement message comprising a function enablement message and a corresponding signature, the function enablement message comprising a fourth random number, a purported device identity, a purported identity valid value, a functional enable value and a disable value.

18. A server according to claim 16, wherein the server is configured, in response to receiving from an integrated circuit:
a fifth random number;
a device identity;
an identity valid value indicating that the device identity is valid;
a value indicating which enableable function(s) of the integrated circuit is (are) enabled; and
a value indicating which disableable function(s) of the integrated circuit is (are) disabled;
to send a signed function disablement message to the integrated circuit, the signed function disablement message comprising a function disable message and a corresponding signature, the function disable message comprising a sixth random number, a purported device identity, a purported identity valid value, a functional enable value and a disable value.

19. A server according to claim 16, wherein the server is configured, in response to receiving from an integrated circuit:
a seventh random number;
a device identity;
an identity valid value indicating that the device identity is valid; and
a value of a user-defined field;
to send a signed user-defined message to the integrated circuit, the signed user-defined message comprising a user-defined message and a signature, the user-defined message comprising an eighth random number, a purported device identity, a purported identity valid value and a user-defined value.

20. A device initialisation system comprising:
an integrated circuit comprising:
a one-time programmable non-volatile memory; and
a memory controller for the one-time programmable non-volatile memory;
the memory controller configured:
to send a first random number which has been generated in the integrated circuit to a device initialization server; and
in response to receiving a signed device initialization message from the device initialization server, the signed device initialization message comprising a device initialization message and a signature, and the device initialization message comprising a second random number and a device identity;
to determine whether the first and second random numbers are equal and whether the signature is valid; and
in response to determining that the first and second random numbers are equal and that the signature is valid;
to program the device identity into a first part of the one-time programmable non-volatile memory; and
a server according to claim 16 in communication with the integrated circuit.

21. A feature enablement server comprising:
at least one processor; and
memory;
wherein the server is configured, in response to receiving from an integrated circuit:
a third random number;
a device identity;
an identity valid value indicating that the device identity is valid;
a value indicating which enableable function(s) of the integrated circuit is (are) enabled; and
a value indicating which disableable function(s) of the integrated circuit is (are) disabled; and
to send a signed function enablement message to the integrated circuit, the signed function enablement message comprising a function enablement message and a third signature, the function enablement message comprising a fourth random number, a purported device identity, a purported identity valid value, a functional enable value and a disable value.

22. A feature enablement system comprising:
an integrated circuit comprising:
a one-time programmable non-volatile memory, and
a memory controller for the one-time programmable non-volatile memory;
the memory controller configured:
to send a first random number which has been generated in the integrated circuit to a device initialization server; and
in response to receiving a signed device initialization message from the device initialization server, the signed device initialization message comprising a device initialization message and a signature, and the device initialization message comprising a second random number and a device identity;
to determine whether the first and second random numbers are equal and whether the signature is valid, and
in response to determining that the first and second random numbers are equal and that the signature is valid,
to program the device identity into a first part of the one-time programmable non-volatile memory; and
a server according to claim 17 or claim 21 in communication with the integrated circuit.

23. A feature disablement server comprising:
at least one processor; and
memory;
wherein the server is configured, in response to receiving from an integrated circuit:
a fifth random number;
a device identity;
an identity valid value indicating that the device identity is valid;
a value indicating which enableable function(s) of the integrated circuit is (are) enabled; and
a value indicating which disableable function(s) of the integrated circuit is (are) disabled; and
to send a signed function disablement message to the integrated circuit, the signed function enablement message comprising a function disablement message and a fifth signature, the function disablement message comprising a sixth random number, a purported device identity, a purported identity valid value, a functional enable value and a disable value.

24. A feature disablement system comprising:
an integrated circuit comprising:
a one-time programmable non-volatile memory; and
a memory controller for the one-time programmable non-volatile memory,
the memory controller configured,
to send a first random number which has been generated in the integrated circuit to a device initialization server; and
in response to receiving a signed device initialization message from the device initialization server, the signed device initialization message comprising a device initialization message and a signature, and the device initialization message comprising a second random number and a device identity;
to determine whether the first and second random numbers are equal and whether the signature is valid; and
in response to determining that the first and second random numbers are equal and that the signature is valid;
to program the device identity into a first part of the one-time programmable non-volatile memory; and
a server according to claim 18 or claim 23 in communication with the integrated circuit.

25. A method of initializing an integrated circuit, the method comprising:
sending a first random number to a device initialization server;
receiving, from the device initialization server, a signed device initialization message comprising a device initialization message and a corresponding signature, the device initialization message comprising a second random number and a device identity;
determining whether the first and second random numbers are equal;
determining whether the signature is valid; and
in response to determining the first and second random numbers are equal and the signature is valid, programming the device identity into a first part of a one-time programmable non-volatile memory.

26. A method according to claim 25, the method further comprising:
reading the device identity from the first part of the one-time programmable non-volatile memory;
determining whether the device identity read from the first part of the one-time programmable non-volatile memory and the device identity programmed into the first part of the one-time programmable non-volatile memory are equal;
in response to determining that the device identities are equal, programming an identity valid value into a second part of the one-time programmable non-volatile memory.

27. A method according to claim 26, the method further comprising:
reading an identity valid value from the second part of the one-time programmable non-volatile memory;
determining whether the identity valid value read from the second part of the read-only memory and the identity valid value programmed into the second part of the one-time programmable non-volatile memory are equal; and
in response to determining that the identity valid values are equal:
sending a message to the device initialization server for confirming that device initialization has been completed.

28. A method comprising or a method according to claim 28 further comprising:
sending a third random number which has been generated in the integrated circuit to feature enablement server and content of the first, second, third and fourth parts of the one-time programmable memory; and
in response to receiving a signed function enablement message from the feature enablement server, the signed function enablement message comprising a function enablement message and a corresponding signature, the function enablement message comprising a fourth random number, a purported device identity, a purported identity valid value, a functional enable value and a disable value:
determining whether the third and fourth random numbers are equal and whether the signature is valid; and
in response to determining the third and fourth random numbers are equal and that the signature is valid:
programming the function enable value in the third part of the one-time programmable memory.

29. A method according to claim 28, further comprising:
sending a fifth random number which has been generated in the integrated circuit to a feature disablement server and content of the first, second, third and fourth parts of the one-time programmable memory; and
in response to receiving a signed feature disablement message from the feature disablement server, the signed feature disablement message comprising a feature disablement message and a corresponding signature, the feature disablement message comprising a sixth random number, a purported device identity, a purported identity valid value, a function enable value and a disable value:
determining whether the fifth and sixth random numbers are equal and whether the signature is valid; and
in response to determining the fifth and sixth random numbers are equal and that the signature is valid:
programming the disable value in the fourth part of the one-time programmable memory.

30. A method according to claim 29, further comprising:
sending a seventh random number which has been generated in the integrated circuit to a user server and content of a fifth part of the one-time programmable memory; and
in response to receiving a signed user-defined field message from the user server, the signed feature disablement message comprising a feature disablement message and a corresponding signature, the user-defined field message comprising an eighth random number, a purported device identity, a purported identity valid value and a user-defined field value:
determining whether the seventh and eighth random numbers are equal and whether the signature is valid; and
in response to determining the seventh and eighth random numbers are equal and that the signature is valid:
programming the user-defined field value into the fifth part of the one-time programmable memory.
